(19) United States
(12) Patent Application Publication
(10) Pub. No.: US 2021/0276308 A1
(43) Pub. Date: Sep. 9, 2021

(54) MANUFACTURING METHOD OF PANEL MEMBER

(71) Applicant: SANWA SCREEN CO., LTD., Aisai-shi (JP)

(72) Inventors: Yoshihide Goto, Aichi (JP); Akira Kuroda, Aichi (JP); Kenshi Sakuma, Aichi (JP)

(21) Appl. No.: 17/147,513

(22) Filed: Jan. 13, 2021

(30) Foreign Application Priority Data
Mar. 5, 2020 (JP) 2020-037469

(51) Int. Cl. B32B 21/08; B27K 5/00; B27D 1/08; B27D 1/06

(52) U.S. Cl. CPC B32B 21/08; B27K 5/0075; B32B 2307/412; B27D 1/06; B27D 1/08

(57) ABSTRACT

A manufacturing method of a panel member (1) in accordance with the present invention includes: a processing step of processing a veneer sheet (2), which is obtained by processing wood into a sheet, into a predetermined desired shape; and a resin molding step of setting the veneer sheet (2), which has been processed in the processing step, on a mold M1 and pouring a transmissive resin onto a front surface side of the veneer sheet (2) to mold a base material part (3). The base material part (3) is molded such that the plate thickness thereof gradually changes.

### BACKGROUND OF THE INVENTION

### 1. Field of the Invention

The present invention relates to a manufacturing method of a panel member used for a vehicle interior decorative part and the like.

### 2. Description of the Related Art

Nowadays, vehicle interior decorative parts, home appliances, and the like use woodgrain or carbon-like designs for the surfaces thereof. Panel members that are illuminated by light from internal light sources are also well known.

Well-known methods of printing such designs include a method in which a wood grain pattern is printed on a resin sheet and the sheet is subjected to insert injection molding, a method in which the sheet is formed into a desired shape and directly attached to an injection-molded product, and a method in which wood is cut into a desired shape and then coated with a transmissive paint or the like.

For example, according to the manufacturing method of a genuine wood product described in Patent Document 1 below, a base material layer is formed by lamination and insert-molded on the back surface side of a wooden veneer by an injection molding operation using a synthetic resin. Subsequently, the insert molded product is humidified to swell the veneer constituting the insert molded product. After that, the swollen veneer is dried, and the front surface of the dried veneer is subjected to relief processing to form an uneven design surface (Patent Document 1/paragraphs 0022 and 0023, FIG. 1).

Patent Document 1: Japanese Patent Application Laid-Open No. 2015-157431

A member processed using wood, as with the veneer in Patent Document 1, can utilize a pattern or shine peculiar to the wood as a design. However, when applying gradation in which a color gradually changes, it is necessary to perform print coloring or paint coloring of the gradation directly on the wood. This has been posing a problem in that the original beauty of the wood is impaired.

### SUMMARY OF THE INVENTION

The present invention has been made in view of the circumstances described above, and an object of the invention is to provide a manufacturing method of a panel member having a design that does not impair a wood grain pattern and shine peculiar to wood.

The present invention is a manufacturing method of a panel member composed of a veneer sheet made by processing wood into a sheet and a base material part made of a transmissive resin, including: a processing step of processing the veneer sheet into a predetermined desired shape; and a resin molding step of setting the veneer sheet processed in the processing step on a mold and pouring the transmissive resin onto a front surface side of the veneer sheet to mold the base material part, wherein the base material part is molded such that a plate thickness thereof gradually changes.

According to the arrangement of the present invention, the veneer sheet is processed into a desired shape of a panel member in the processing step according to the application of the veneer sheet. After the processed veneer sheet is set on a mold, a transmissive resin is poured into the mold thereby to mold the base material part on the front surface side of the veneer sheet in the resin molding step.

The base material part is molded such that the plate thickness thereof gradually changes, so that the reflected light of light incident from a surface of the base material part changes depending on a portion, and the appearance of wood grain changes accordingly. Thus, the present manufacturing method can manufacture a panel member having a design that does not impair the pattern or shine peculiar to wood.

In the manufacturing method of a panel member in accordance with the present invention, a curved recessed or projected portion can be formed on at least one part of the veneer sheet in the processing step.

In the processing step, if a curved recessed or projected portion is firmed on a part of the veneer sheet, then the part can also cause the reflected light of the light incident from a surface of the base material part to gradually change. Thus, the present manufacturing method makes it possible to produce a panel member that exhibits unique shading in addition to wood grain.

Further, the manufacturing method of a panel member in accordance with the present invention may include a transmissive layer molding step of molding a back surface transmissive layer on the back surface side of the veneer sheet by the transmissive resin.

In the transmissive layer molding step, a transparent transmissive layer is molded (e.g., by injection molding) on the back surface side of the veneer sheet thereby to cover the veneer sheet. Consequently, the moisture-proof effect of the veneer sheet can be enhanced. Further, in the panel member manufactured by the present manufacturing method, the shade of a wood grain pattern changes depending on the thickness of the transmissive layer on the back surface side.

Further, the manufacturing method of a panel member in accordance with the present invention may include: a light-shielding layer forming step of forming a light-shielding layer on at least one part of the back surface transmissive layer opposite from the veneer sheet; an opening forming step of forming an opening through which light enters in one portion of the light-shielding layer; and an opening covering step of covering the opening by a transmissive sheet.

In the light-shielding layer forming step, a light-shielding layer is formed by painting or the like on one part of the back surface transmissive layer on the opposite side from the veneer sheet (i.e., the back surface side). Further, in the opening forming step, an opening through which light enters is formed by laser or the like. Further, in the opening covering step, the opening is covered by a transmissive sheet. Consequently, a part member manufactured by the present manufacturing method can display a design such as a character or a figure according to the shape of an opening from the front surface side of the panel member when light enters through the opening.

Further, the manufacturing method of a panel member in accordance with the present invention may include a back surface light-shielding layer molding step of molding a back surface light-shielding layer on the back surface side of the veneer sheet by a light-shielding resin.

In the back surface light-shielding layer molding step, the back surface light-shielding layer is molded (e.g., by injection molding) by using a light-shielding resin, which has opaque properties, on the back surface side of the veneer sheet thereby to cover the veneer sheet. This can also form an opening, through which light enters, in a part of the back surface light-shielding layer. In addition, covering the opening by a transmissive sheet enables the panel member to display a design such as a character or a figure according to the shape of the opening from the front surface side of the panel member when light enters through the opening.

Further, in the manufacturing method of a panel member in accordance with the present invention, the transmissive sheet is preferably colored with a predetermined color.

According to the present manufacturing method, by coloring the transmissive sheet, the color of a design visually recognized from the front surface side of a panel member can be changed without changing a light source.

### BRIEF DESCRIPTION OF THE DRAWINGS

FIG. 1 is a perspective view of a panel member manufactured by the manufacturing method in accordance with the present invention;

FIG. 2A is a diagram illustrating a forming step of the manufacturing method in accordance with the present invention, FIG. 2B is a diagram illustrating a mold mounting step of the manufacturing method in accordance with the present invention, and FIG. 2C is a diagram illustrating a resin molding step of the manufacturing method in accordance with the present invention;

FIG. 3 is a sectional view of a panel member manufactured by the manufacturing method of a first embodiment;

FIG. 4 is an enlarged view of a region R1 and a region R2 of FIG. 3;

FIG. 5 is a diagram illustrating a modified form of a veneer sheet;

FIG. 6 is a perspective view of a panel member that adopts the veneer sheet in FIG. 5;

FIG. 7 is a sectional view of a panel member manufactured by the manufacturing method of a second embodiment;

FIG. 8 is a perspective view illustrating a design example displayed on the panel member of FIG. 7; and

FIG. 9 is a sectional view of a panel member manufactured by the manufacturing method of the second embodiment (modified form).

### DESCRIPTION OF THE PREFERRED EMBODIMENTS

The following will describe embodiments of manufacturing method of panel members according to the present invention.

### First Embodiment

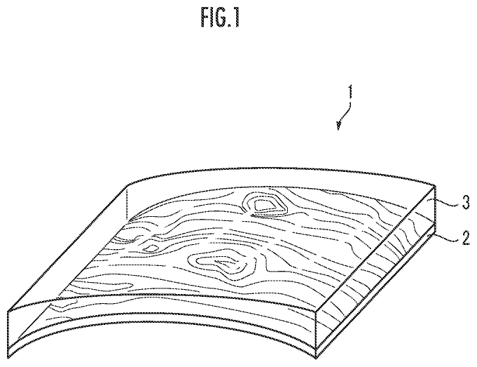

FIG. 1 is a perspective view of a panel member 1 manufactured by the manufacturing method of the present invention. The panel member 1 is a wood grain pattern panel used for a vehicle interior part (e.g., a shift lever panel and an instrument panel). The panel member 1 is mainly composed of a veneer sheet 2 of genuine wood and a base material part 3 having transmittivity.

The veneer sheet 2 is a member obtained by processing natural wood, such as cedar, Japanese cypress, zelkova, curly maple, tamo, and white wood, into a sheet having a thickness of approximately 0.1 to 0.5 mm. The wood that is the source of the veneer sheet 2 has ducts (vessels) for carrying water to the tips of a trunk and branches, and when the wood is formed into a sheet, the ducts appear on a surface of the sheet.

The shape and size of the ducts vary depending on the type of wood. Further, different wood grain patterns appear depending on a viewing angle due to the influence of reflection and diffusion of light incident on the duct, and the appearance of light (so-called “shine”) changes. The panel member 1 is characterized by having a design that does not impair the wood grain pattern and the shine of genuine wood.

The base material part 3 is a member obtained by injection-molding a resin having transmittivity (“transmissive resin” in the present invention). The resin is, for example, polycarbonate (PC), polymethyl methacrylate resin (PMMA), polyethylene terephthalate resin (PET), or ABS resin, and a wood grain pattern and shine is clearly recognized from the front surface side of the panel member 1.

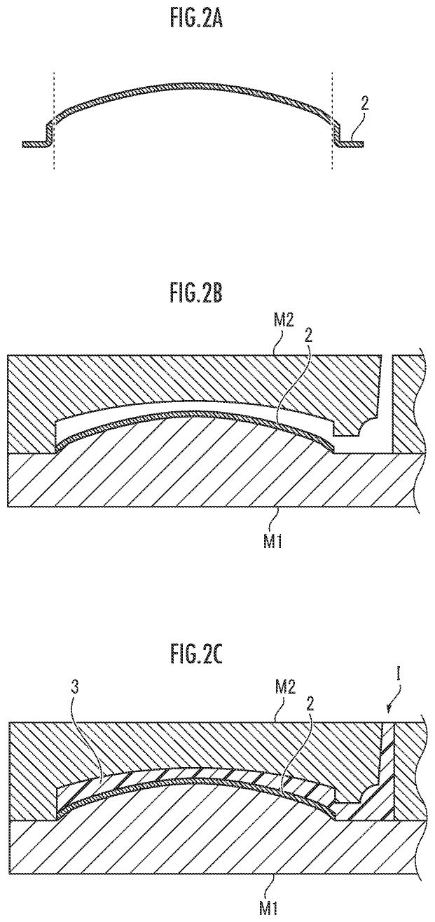

Referring now to FIG. 2, the manufacturing method of the panel member 1 will be described.

First, the veneer sheet 2 is formed. This is a step of processing the veneer sheet 2 into a desired shape (e.g., curved shape) (refer to FIG. 2A). As the forming method, pressing, vacuum forming, vacuum pressure forming, ultrahigh pressure forming or the like is used.

Next, the veneer sheet 2 is trimmed. This is a step of cutting off the end portions of the formed veneer sheet 2 by a press, laser, Thomson processing, a cutter, or other cutting tool so as to form the veneer sheet 2 into a shape that enables mounting on a mold for injection molding. In FIG. 2A, the veneer sheet 2 is cut at the dashed lines, and the outer portions thereof are removed.

Next, the trimmed veneer sheet 2 is mounted on (inserted into) a lower mold M1 and properly covered with an upper mold M2 (refer to FIG. 2B). In the forming step, the veneer sheet 2 is processed to match the curved surface of the mold M1, so that when the veneer sheet 2 is attached to the mold M1, the veneer sheet 2 comes in contact without a gap. Further, as illustrated in FIG. 2B, the mold M2 has a surface shape in which the central portion thereof is thin and the thickness increases toward the end portions thereof.

Next, injection molding is performed. More specifically, a resin having transmittivity is poured through a resin injection port I of the upper mold M2 (refer to FIG. 2C). Consequently, a panel member (prototype) with the base material part 3 molded on the front surface side of the veneer sheet 2 can be manufactured.

Lastly, an unnecessary portion of the resin having transmittivity is cut off to complete the panel member 1. As illustrated in the drawings, the resin in the resin injection port 1 portion is connected to one end portion of the panel member 1, so that the connected portion is cut off. Thus, the whole process of the manufacturing method of the present invention is completed.

FIG. 3 is a sectional view of the panel member 1 that has been completed.

By the manufacturing method described above, the base material part 3 is molded such that the thickness (the plate thickness) thereof increases toward the end portions of the base material part 3. More specifically, the plate thickness of the central portion of the base material part 3 is approximately 1.0 mm and the plate thickness of each end portion of the base material part 3 is approximately 5.0 mm.

The base material part 3 is not limited to the shape illustrated in FIG. 3 insofar as the plate thickness gradually changes. For example, the base material part 3 may be molded such that the plate thickness decreases toward the end portions of the base material part 3, or may be molded such that a thick portion and a thin portion alternately appear.

As described above, there are many small ducts (15 to 40 μm in diameter) on the surface of the veneer sheet 2, but a diameter of 600 μm or more is required for a translucent resin melted in the injection molding step to be poured into the ducts. Hence, the resin does not run into the ducts in this step, thus leaving the ducts in a hollow state. This means that the light incident from the front surface side of the panel member 1 is reflected and scattered inside the ducts.

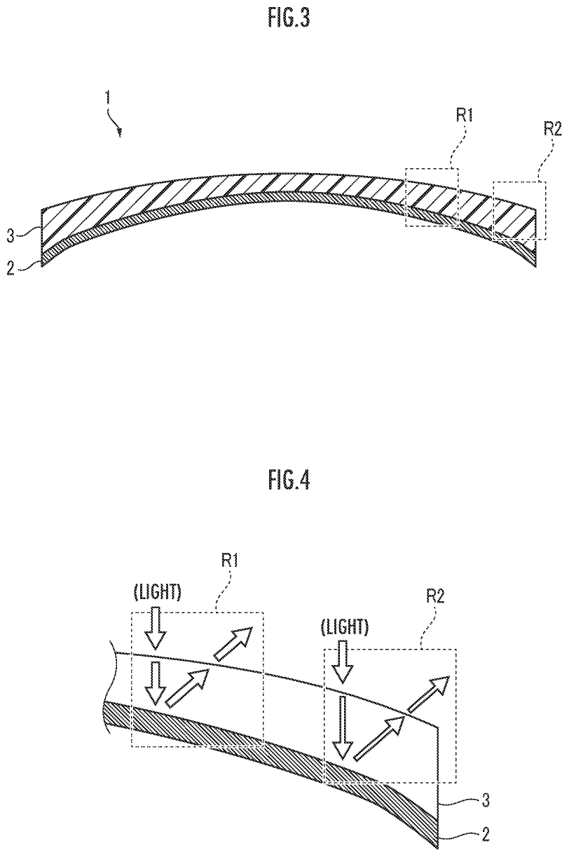

FIG. 4 is an enlarged view of an end portion of the panel member 1.

In a region R1 where the plate thickness of the base material part 3 is relatively thin, the amount of attenuation of light incident on the transmissive resin from the front surface side of the base material part 3 is small. Therefore, the wood grain pattern and the shine of the veneer sheet 2 are visually recognized by a user as reflected light in the ducts.

On the other hand, in a region R2 where the plate thickness of the base material part 3 is relatively large, the amount of attenuation of light incident on the resin is large. Therefore, the reflected light from the veneer sheet 2 is weakened, and the resin color looks dark. However, since the base material part 3 has transmittivity, the wood grain pattern and the shine of the veneer sheet 2 are visually recognized by the user also as reflected light.

Thus, by molding the base material part 3 such that the plate thickness thereof increases toward the end portions thereof, the shade of the resin color gradually changes due to a decrease in light transmittance, and a unique gradation appears. This is because the direct joining of the front surface side of the veneer sheet 2 and the base material part 3 prevents the ducts of the veneer sheet 2 from being blocked, so that the “shine” is not impaired.

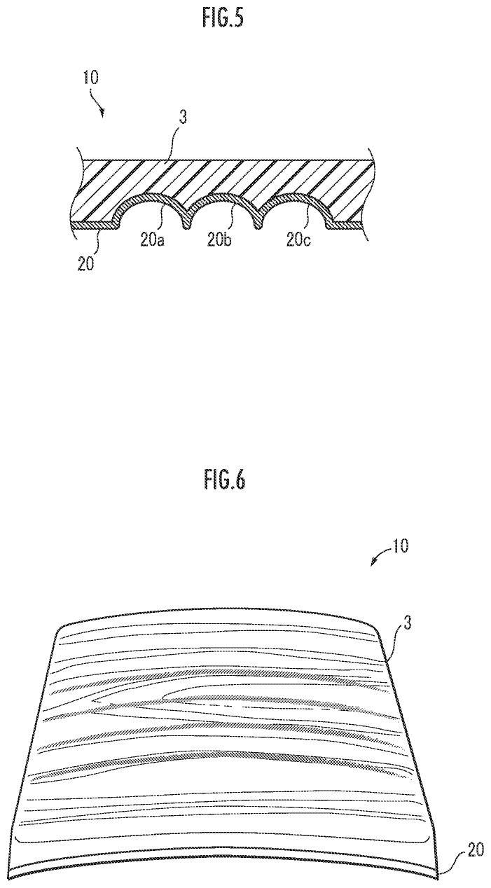

As illustrated in FIG. 5, in the forming step, a recessed portion or a projected portion may be formed on at least one part of the veneer sheet. A veneer sheet 20 of a panel member 10 has projected portions 20a to 20c that are curved and projected toward a base material part 3.

When using the veneer sheet 20, it is necessary to prepare and mount (insert) a mold that matches the shape of the veneer sheet 20. Further, in the injection molding step, for example, a transmissive resin such as PMMA colored in brown is poured through the resin injection port I of the upper mold (refer to FIG. 2C). Consequently, a panel member (prototype) with the base material part 3 molded on the front surface side of the veneer sheet 20 can be manufactured. The veneer sheet 20 may have a curved recessed portion.

FIG. 6 is a perspective view of the panel member 10 produced by cutting an unnecessary portion of the resin from the foregoing panel member (prototype).

In the panel member 10, four straight linear gradation patterns appear in the wood grain pattern due to the influence of the projected portions 20a to 20c of the veneer sheet 20. These straight lines are darker brown than the remaining part, thus making it possible to form a three-dimensional pattern with depth and shading.

The straight lines (darker parts) correspond to the thicker part of the PMMA in the sectional view of FIG. 5. Obviously, the wood grain pattern and shine are not impaired on the entire surface of the panel member 10.

### Second Embodiment

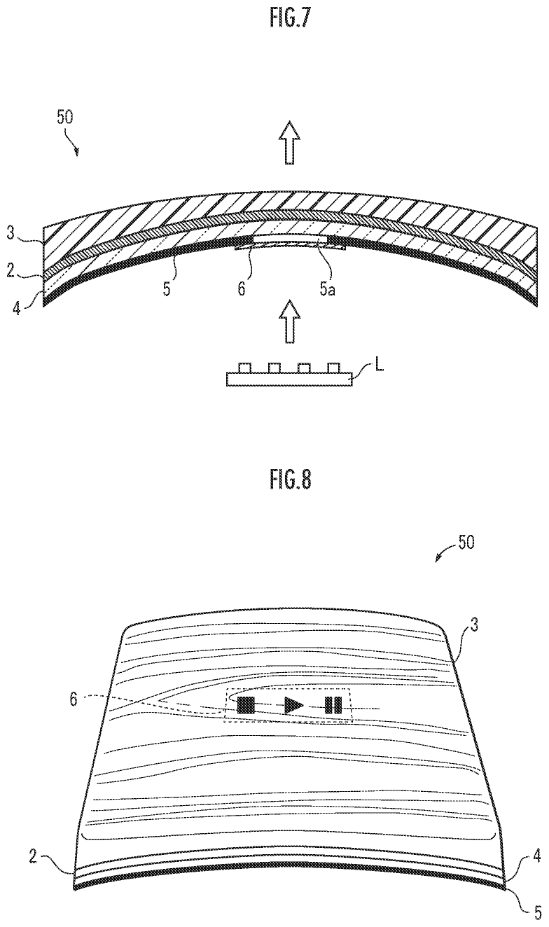

Lastly, a second embodiment of the panel member will be described with reference to FIG. 7 and FIG. 8.

FIG. 7 is a sectional view of a panel member 50 of the second embodiment. The same components as those in the first embodiment will be denoted by the same reference numerals, and the descriptions thereof will be partly omitted. The process up to the molding of a base material part 3 on the upper surface side of a veneer sheet 2 is no different from the method described in the first embodiment.

After molding the base material part 3 on the upper surface side of the veneer sheet 2, a back surface transmissive layer 4 made of a transmissive resin is molded on the back surface side (the side without the base material part 3) of the veneer sheet 2 by injection molding. The thickness of the back surface transmissive layer 4 is preferably approximately 1.0 to 5.0 mm, and the thickness may be uniform or varied between the central portion and the end portions of the base material part 3. Consequently, the veneer sheet 2 is covered with the resin, and the moisture-proof effect of the veneer sheet 2 can be enhanced. Further, depending on the thickness of the back surface transmissive layer 4, the shading of a wood grain pattern changes.

Next, a light-shielding layer 5 is formed on the back surface side (the side without the veneer sheet 2) of the back surface transmissive layer 4 by painting or the like. The light-shielding layer 5 is a thin film of an ink, e.g., a black pigment containing carbon black, which easily absorbs the laser light (Nd: YAG, CO₂ laser, or the like) of a laser marking device. The thickness of the light-shielding layer 5 is preferably approximately 10 to 40 μm, and may be formed on the entire back surface side of the back surface transmissive layer 4 or may be formed on a part thereof.

Next, an opening 5a into which light enters is formed in one part of the light-shielding layer 5. For example, the light-shielding layer 5 is peeled off by a YAG laser so as to have a shape of a character, a figure, a switch mark or the like.

Lastly, the opening 5a is covered with a transmissive sheet 6. The material of the transmissive sheet 6 is a transmissive resin such as PC, PMMA, or PET, and the thickness thereof is preferably approximately 50 to 300 μm. Consequently, when the light from an LED of a light source substrate L enters the panel member 50 through the opening 5a, a design such as a character, a figure or the like matching the shape of the opening 5a is displayed on the surface of the panel member 50.

The transmissive sheet 6 may be colored in a predetermined color. Coloring the transmissive sheet 6 makes it possible to change the color of a design visually recognized from the front surface side of the panel member 50 without changing the light source substrate L.

FIG. 8 is a perspective view of the panel member 50 described above.

The panel member 50 remains as a panel with a wood grain pattern covering the entire surface thereof when the LED of the light source substrate L placed on the lower surface side of the panel member 50 is not emitting light. However, when the LED emits light, the marks (denoting “stop,” “play,” and “pause”) as illustrated in the drawing can be displayed on the wood grain pattern. The transmissive sheet 6 (the portion indicated by the dashed line in the drawing) is placed so as to correspond to each of the marks or to cover the entire mark area.

Thus, the panel member 50 is used, for example, as an in-vehicle panel, and implements a performance in which a specific design appears only when the LED of the light source substrate L is turned on. At this time, the wood grain pattern and shine an not impaired on the entire surface of the panel member 50.

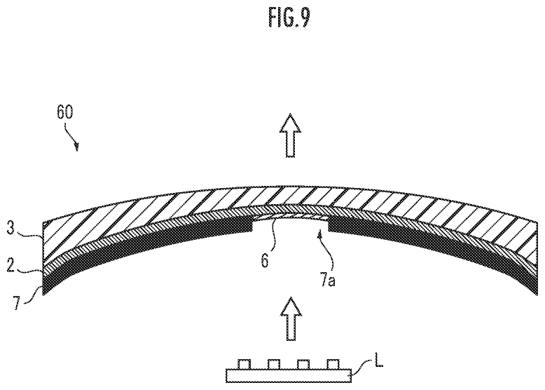

Lastly, FIG. 9 illustrates a cross-sectional view of a panel member 60 of a modified embodiment.

In this case, after a base material part 3 is molded on the upper surface side of the veneer sheet 2, a back surface light-shielding layer 7 made of a resin having opaque properties is molded on the back surface side (the side without the base material part 3) of the veneer sheet 2 by injection molding. The thickness of the back surface light-shielding layer 7 is preferably approximately 1.0 to 5.0 mm. The back surface light-shielding layer 7 may be molded on the entire back surface side of the veneer sheet 2, or may be molded on a part thereof.

The subsequent process is the same except that an opening 7a through which light enters is formed in a part of the back surface light-shielding layer 7. For example, the back surface light-shielding layer 7 is processed into a predetermined shape by laser processing or the like. Further, the veneer sheet 2 in the opening 7a is covered with a transmissive sheet 6. In this mode also, when the light of the LED of a light source substrate L is incident on the panel member 60 through the opening 7a, a design such as a character or a figure matching the shape of the opening 7a is displayed on the surface of the panel member 60.

Although the embodiments for carrying out the present invention have been described above, the present invention is not limited to the above embodiments and can be modified when necessary without departing from the gist of the present invention.

The panel member 1 of the first embodiment (refer to FIG. 3) and the panel member 50 of the second embodiment (refer to FIG. 7) are illustrated in section viewed from one direction, but both panel members are preferably molded such that the plate thicknesses of the base material parts 3 thereof gradually change as viewed from any direction.

For example, the base material parts 3 of the panel members 1 and 50 may be molded such that the thicknesses of the base material parts 3 increase toward the end portions thereof as viewed from any direction. The same applies to the panel member 10 (refer to FIG. 5).

The panel member 50 of the second embodiment (refer to FIG. 7) can be used without the light-shielding layer 5 and the transmissive sheet 6, or without the light-shielding layer 5. For example, placing a light source substrate for a seven-segment LED, which can display time, on the lower surface side of such a panel member makes it possible to cause a digital clock to appear when the light source is turned on.

### DESCRIPTION OF REFERENCE NUMERALS

1, 10, 50, 60 panel member

2 veneer sheet

3 base material part

4 back surface transmissive layer

5 light-shielding layer

5a opening

6 transmissive sheet

7 back surface light-shielding layer

7a opening

20 veneer sheet

20a to 20c projected portion

L light source substrate

M1, M2 mold

What is claimed is:

1. A manufacturing method of a panel member composed of a veneer sheet, which is obtained by processing wood into a sheet, and a base material part made of a transmissive resin, comprising:
a processing step of processing the veneer sheet into a predetermined desired shape; and
a resin molding step of setting the veneer sheet processed in the processing step on a mold and pouring the transmissive resin onto a front surface side of the veneer sheet to mold the base material part,
wherein the base material part is molded such that a plate thickness thereof gradually changes.

2. The manufacturing method of a panel member according to claim 1,
wherein a curved recessed or projected portion is formed on at least a part of the veneer sheet in the processing step.

3. The manufacturing method of a panel member according to claim 1, including:
a transmissive layer molding step of molding a back surface transmissive layer by the transmissive resin on a back surface side of the veneer sheet.

4. The manufacturing method of a panel member according to claim 3, including:
a light-shielding layer forming step of forming a light-shielding layer on at least one part of the back surface transmissive layer opposite from the veneer sheet;
an opening forming step of forming an opening through which light enters in one portion of the light-shielding layer; and
an opening covering step of covering the opening by a transmissive sheet.

5. The manufacturing method of a panel member according to claim 1, including:
a back surface light-shielding layer molding step of molding a back surface light-shielding layer by a light-shielding resin on a back surface side of the veneer sheet.

6. The manufacturing method of a panel member according to claim 4,
wherein the transmissive sheet is colored with a predetermined color.
